(19) United States
(12) Patent Application Publication
(10) Pub. No.: US 2024/0199246 A1
(43) Pub. Date: Jun. 20, 2024

(54) EXTERNAL CAGE FOR UNMANNED AERIAL VEHICLE

(71) Applicant: HARDSHELL LABS, INC., Haines, AK (US)

(72) Inventor: Timothy A. Shields, Haines, AK (US)

(21) Appl. No.: 18/261,076

(22) PCT Filed: Jan. 12, 2022
(86) PCT No.: PCT/US2022/012193

§ 371 Date: Jul. 11, 2023

Related U.S. Application Data
(60) Provisional application No. 63/137,050, filed on Jan. 13, 2021.

(51) Int. Cl. B64U 30/299

(52) U.S. Cl. CPC B64U 30/299

(57) ABSTRACT

Systems and methods are provided for maintaining operation of an unmanned aerial vehicle (UAV) in an obstructive environment. In one example, the UAV may include a plurality of propellers, a plurality of guards affixed to the plurality of propellers, and a cage positioned adjacent to the plurality of propellers, the cage constructed from a plurality of detachably joined beams, and the cage detachably coupled to each of the plurality of guards. In some examples, the cage may be fabricated from fiberglass or carbon fiber. In additional or alternative examples, the cage may not extend underneath the UAV during operation thereof. In this way, the cage may maintain operation of the UAV in the obstructive environment by preventing obstructing objects in the obstructive environment from damaging components thereof while providing a substantially lightweight and unobtrusive construction which may not significantly degrade a performance of the UAV.

### CROSS-REFERENCE TO RELATED APPLICATIONS

The present application claims priority to U.S. Provisional Application No. 63/137,050, entitled “EXTERNAL CAGE FOR UNMANNED AERIAL VEHICLE,” and filed on Jan. 13, 2021. The entire contents of the above-identified application are hereby incorporated by reference for all purposes. In addition, where an element of the international application referred to in Article 11(1)(iii)(d) or (e), or a part of the description, claims or drawings referred to in Rule 20.5(a), or an element or part of the description, claims or drawings referred to in Rule 20.5bis(a) is not otherwise contained in the present international application but is completely contained in the earlier provisional application, that element or part is, subject to confirmation under Rule 20.6, incorporated by reference in this international application for the purposes of Rule 20.6.

### FIELD

The present description relates generally to systems and methods for external lightweight, low drag, shock-absorbing. 3-dimensional external cages (“Carapace”) for unmanned aerial vehicles (“UAVs”), particularly for protection of humans, animals, natural and man-made objects and for maintaining flight and continued functionality of the UAVs in obstructive environments.

### BACKGROUND AND SUMMARY

UAVs may be used for numerous commercial and personal applications, including delivery of goods, scientific surveys, aerial photography, agriculture, monitoring of power transmission lines and pipelines, disaster response, military and police operations, ecological monitoring and recreation. However, environments in which the UAVs operate often include numerous obstructing objects. These include obstructions which need to be protected from damage by the UAVs, such as humans, animals, and natural and man-made objects. Conversely, the UAVs themselves need protection from damaging collisions with obstructions, including the ground that may undesirably interrupt rotational motion of propellers of the given UAV, potentially disrupting flight and damaging the UAV.

External cages have been developed for UAVs which may provide at least some deflective protection against such obstructing objects. However, current drone rotor cages on the market are composed of relatively heavy materials and may increase the surface area, thus increasing wind resistance. The inventor herein has recognized these issues as well as the particularly difficult issue of shock absorption by the rotor cage.

The issues described above may be addressed by a UAV including a plurality of propellers, a plurality of propeller guards affixed to the plurality of propellers, and a cage. The guards and/or cage may be provided separately from the UAV and/or propellers in an example. The cage may be adjacent to the plurality of propellers. The cage may be constructed from a plurality of beams detachably joined together via a plurality of crossed mounting tubes or other clasping devices. Further still, the cage may be detachably coupled to each of the plurality of propeller guards or to the plurality of arms of the UAV via purpose built connectors. In an example, the cage may be shaped similar to a carapace, and thus referred to as such. In an example, this modular design enables the carapace to be equipped to exclude smaller items through the addition of rings attached to the main axial elements. Thus, any number of concentric rings can be attached to the axial main spar elements to provide exclusion of smaller objects. The addition of fine mesh over the Carapace is used to exclude the finest structures (leaves, small twigs, etc.)

In an example, the carapace may be constructed from a lightweight material, such as fiberglass, carbon fiber, composite materials or other suitable material. The adaptability of the design allows it to be constructed from a variety of materials. This allows compromises between weight, volume of material, cost, flexibility, and strength. The Carapace can thus be configured to address a wide variety of customer use cases and design requirements.

The carapace's design allows it to be adapted to allow for full functionality of attachments to the UAV, including cameras, sensors, and payload carrying attachments. The design also allows it to be adapted to various UAV configurations, and/or to be adapted to various use cases and customer specifications.

In additional or alternative examples, the cage may be configured to leave an underside of the UAV partially or wholly unobstructed.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a top view of a first embodiment of a lightweight, low drag, shock-absorbing, 3-dimensional external cage for UAVs including a first UAV having a first external cage affixed thereto.

FIG. 2 shows a perspective view of the first embodiment of the UAV system, wherein the UAV system further includes a mesh netting affixed to the external cage.

FIG. 3 shows an enlarged view of the first embodiment of the UAV system, wherein the UAV system further includes the mesh netting.

FIG. 4 shows a first exemplary step of an assembly process for the first embodiment of the UAV system.

FIG. 5 shows a second exemplary step of the assembly process for the first embodiment of the UAV system.

FIG. 6 shows a third exemplary step of the assembly process for the first embodiment of the UAV system.

FIG. 7 shows a fourth exemplary step for the assembly process of the first embodiment of the UAV system.

FIG. 8 shows a fifth exemplary step for the assembly process of the first embodiment of the UAV system.

FIGS. 9A and 9B respectively show first and second enlarged views of an exemplary coupling joint of the first embodiment of the UAV system.

FIG. 10 shows an enlarged view of a first exemplary pairwise beam joint of the first embodiment of the UAV system.

FIG. 11 shows an enlarged view of a second exemplary pairwise beam joint of the first embodiment of the UAV system.

FIG. 12 shows a perspective view of a second embodiment of the UAV system including a second UAV having a second external cage affixed thereto.

FIG. 13 shows a perspective view of a third embodiment of the UAV system including a third UAV having a third external cage affixed thereto.

FIG. 14 shows a perspective view of a fourth embodiment of the UAV system including a fourth UAV having a fourth external cage affixed thereto.

FIG. 15 shows an enlarged view of an exemplary pairwise beam joint of the fourth embodiment of the UAV system.

FIG. 16 shows a flow chart of a method for assembling and operating the UAV system.

FIG. 17 shows a schematic diagram illustrating exemplary operation of the UAV system.

FIG. 18 shows an example connector which may be used as the connection point between the drone and the carapace.

### DETAILED DESCRIPTION

The following description relates to systems and methods for operating an unmanned aerial vehicle (UAV) system in an obstructive environment, with an affixed lightweight, low drag, shock-absorbing. 3-dimensional external cage for UAVs (carapace). The external cage may be configured to maintain operation of the UAV in the obstructive environment while protecting humans and natural and man-made obstructions as well as the components of the UAV from damage. The flexibility of the cage structure provides resilient protection with low drag, low weight. Further, in an example, the collapsible and flexible nature of the cage provides impact and energy absorption.

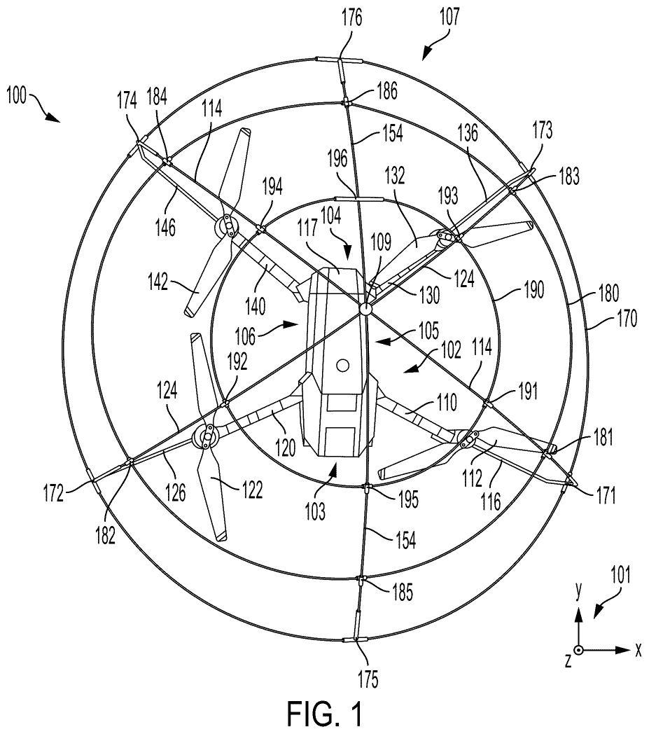

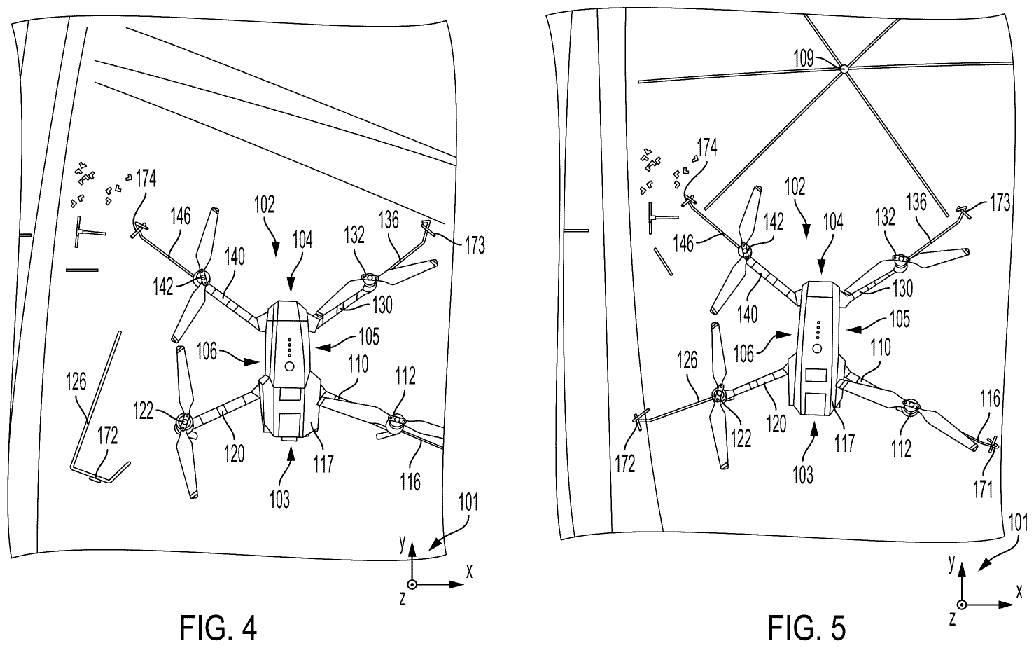

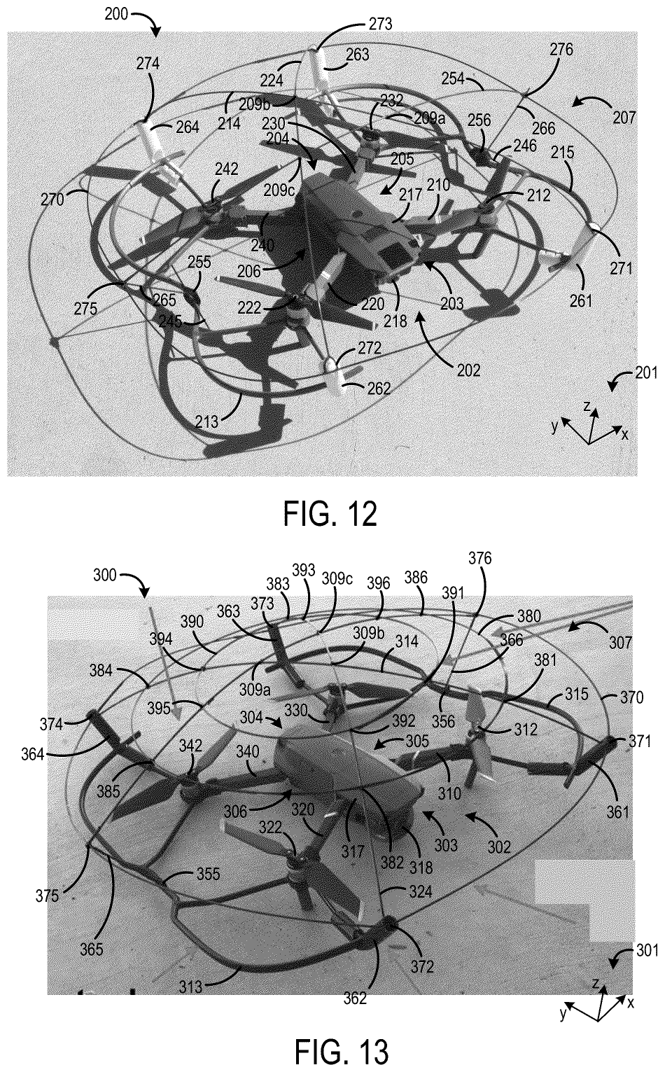

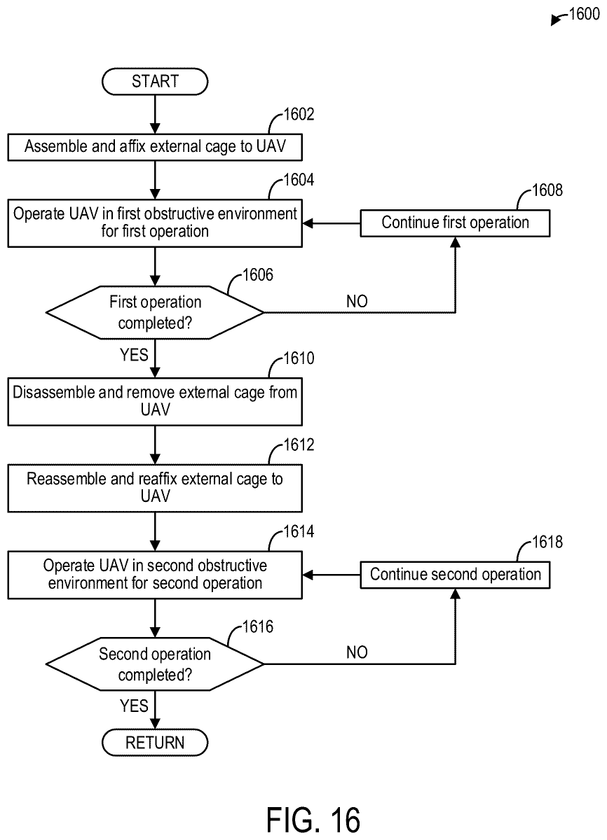

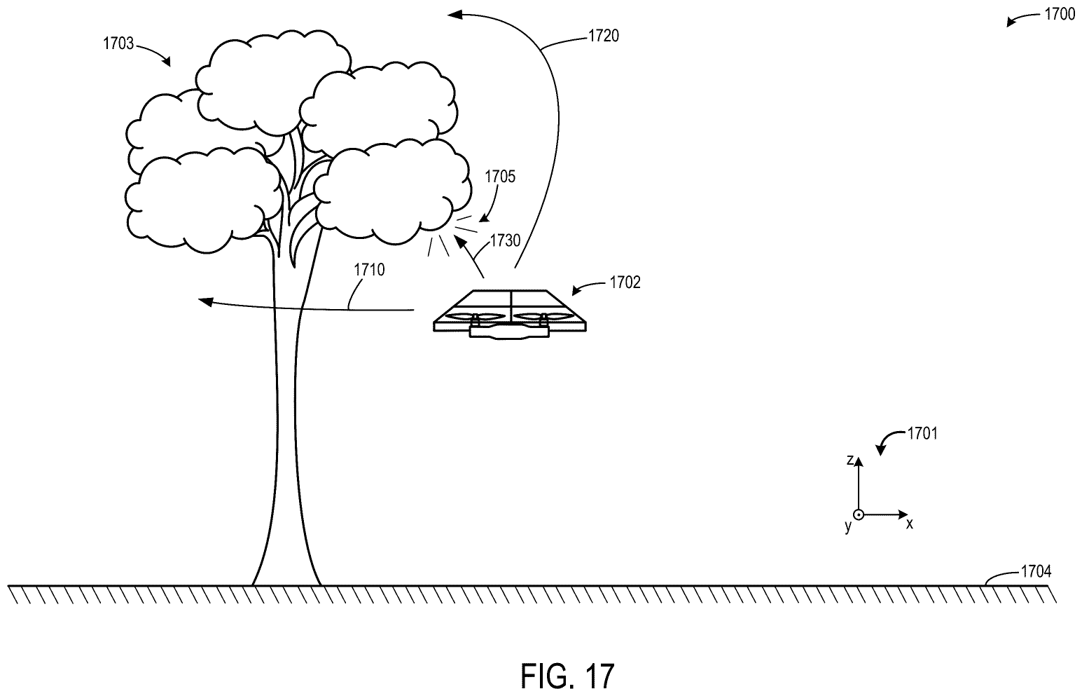

Views of a first embodiment of the UAV system are depicted in FIGS. 1-3 and 9A-11, and exemplary steps of an assembly process for the first embodiment of the UAV system are depicted in FIGS. 4-8. Views of further embodiments of the UAV system are variously depicted in FIGS. 12-15. A method of assembling and operating the UAV system during two exemplary operations is depicted by the flow chart of FIG. 16. Exemplary operation of the UAV system is schematically depicted in FIG. 17. FIGS. 1-15 are shown to scale.

Referring now to FIGS. 1-11, a first embodiment of a UAV system 100 is depicted, the UAV system 100 including an external cage 107 affixed to a UAV 102. Accordingly, components with similar configurations depicted variously among FIGS. 1-11 may be labeled with corresponding numbers (e.g., a first curved beam may be labeled with “114” with respect to FIGS. 1-3, 6-7B, and 9). Further, individual components may be introduced and described below with reference to a figure in which such components first appear (e.g., the first curved beam 114 may be introduced and described with reference to FIG. 1), and may or may not be supplemented with further description thereafter. A set of reference axes 101 are provided for describing relative positioning of the components shown and for comparison between the views of FIGS. 1-11, the axes 101 indicating an x-axis, a y-axis, and a z-axis. In one example, the z-axis may be parallel with a direction of gravity and a vertical direction, the x-axis parallel with a horizontal (e.g., lateral) direction, and the y-axis parallel with a transverse (e.g., longitudinal) direction of the UAV 102. During operation, the UAV 102 may be considered to move, with respect to the axes 101, upwards along the z-axis in a positive direction, downwards along the z-axis in a negative direction, leftwards along the x-axis in a positive direction, rightwards along the x-axis in a negative direction, backwards along the y-axis in a positive direction, and forwards along the y-axis in a negative direction.

Referring now to FIG. 1, a top view depicting the UAV system 100 is shown. The UAV system 100 may include the external cage 107 removably affixed to the UAV 102. The UAV 102 may be described with reference to a front side 103, a rear side 104, a port side 105, and a starboard side 106. For example, a plurality of arms may extend from a body 117 of the UAV 102, the plurality of arms including a first arm 110 extending from the port side 105 adjacent to the front side 103, a second arm 120 extending from the starboard side 106 adjacent to the front side 103, a third arm 130 extending from the port side 105 adjacent to the rear side 104, and a fourth arm 140 extending from the starboard side 106 adjacent to the rear side 104. A plurality of propellers may be respectively positioned at ends of the plurality of arms at opposite ends thereof from the body 117. Specifically, a first propeller 112 may be positioned at an end of the first arm 110 opposite the body 117, a second propeller 122 may be positioned at an end of the second arm 120 opposite the body 117, a third propeller 132 may be positioned at an end of the third arm 130 opposite the body 117, and a fourth propeller 142 may be positioned at an end of the fourth arm 140 opposite the body 117. It will be appreciated that the UAV 102, while depicted in FIGS. 1-11 in a “quadcopter” configuration (e.g., having four propellers), may include greater or fewer propellers within the scope of the present disclosure.

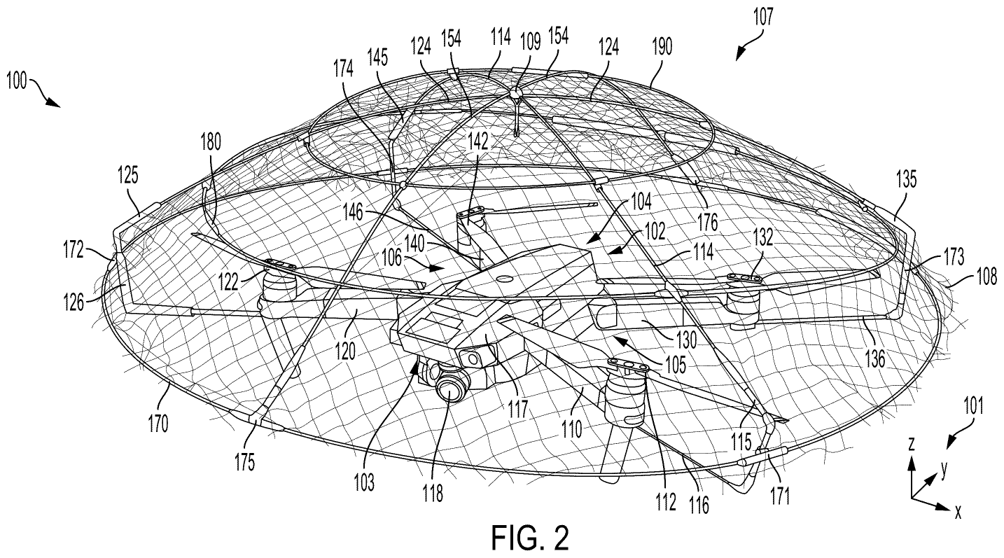

The UAV 102 may be remotely controlled by an operator, semi-autonomous, or substantially fully autonomous, and may have one or more applications, such as delivery, scientific surveys and mapping, aerial photography, agriculture, monitoring power transmission lines and pipelines, disaster response, ecological monitoring, etc. As such, in some examples, the UAV 102 may be a commercially available “drone” including one or more functionalities for executing the one or more applications. For example, the UAV 102 may include a camera for capturing photographs (as described in detail below with reference to FIG. 2), a dispensing device for releasing chemicals, feedstock, probes, etc., and/or mechanical fixtures for securing a package or other payload.

In some examples, the UAV 102 may be operated in an obstructive environment having a plurality of obstructing objects. The plurality of obstructing objects may interfere with rotation of the plurality of propellers, disrupting operation of the UAV 102 and potentially damaging components thereof. For example, the UAV 102 may desirably be operated in relatively dense plant foliage, such as in a tree canopy, during ecological monitoring (e.g., of an avian habitat). In addition to plant foliage, the obstructive environment may include rock or other earth formations (e.g., cliff faces), building interiors (e.g., within aircraft hangars), utility, radio, cell or other transmission towers, and adjacent to building rooftops (e.g., wherein the plurality of obstructing objects may include guywires, ventilation fans, antennae, etc.), and the like. Further, live birds present a collision hazard from which the UAV can also be protected. This feature will facilitate operations in environments with high densities of birds. In addition, the protection afforded to the above obstructive objects in the event of a collision with a carapace equipped UAV is an advantage of the design. This protection will extend to humans, livestock, pets and wildlife as well as to sensitive infrastructure such as antennas and vulnerable features of buildings.

Accordingly, the external cage 107 may be affixed to the UAV 102 to maintain uninterrupted rotation of the plurality of propellers when a given obstructing object in the obstructive environment contacts the external cage 107. As such, in certain examples wherein one or more avoidance sensors are implemented on the UAV 102 to prevent physical contact of the UAV 102 with a given obstructing object, the one or more avoidance sensors of the UAV 102 may be deactivated or omitted and the external cage 107 may instead be relied upon for preventing physical contact of the UAV 102 with the given obstructing object. In this way, operation of the UAV 102 may be enabled in otherwise inaccessible environments, as the external cage 107 may permit a closer approach of the UAV 102 to obstructing objects than avoidance sensors.

The external cage may be constructed from a plurality of beams detachably joined together via a plurality of beam joints (also referred to herein as “crossed mounting tubes,” but may include other clasping devices). The beams may also be spars in an example. In an exemplary embodiment, the plurality of beams may include a plurality of curved beams and one or more concentric beams (e.g., curved beams affixed at opposing ends to form one or more concentric circles sharing a center with an approximate center of mass of the body 117 along the z-axis). A number of the plurality of curved beams, a number of the one or more concentric beams, and a number of the plurality of beam joints, as well as a composition of the plurality of beams and the plurality of beam joints, may be selected so as to reduce a total weight of the UAV system 100 while not permitting obstructing objects of the obstructing environment above a threshold size. For instance, the plurality of curved beams may include at most three curved beams, the one or more concentric beams may include at most three concentric beams, and the plurality of beam joints may include at most eighteen pairwise beam joints. Additionally or alternatively, the plurality of beams may be formed from a lightweight material, such as carbon fiber or fiberglass.

In the UAV system 100, and as shown at FIG. 1, the plurality of curved beams may include only three curved beams: a first curved beam 114, a second curved beam 124, and a third curved beam 154. Further, in the UAV system 100, the one or more concentric beams may include only three concentric beams: a first concentric beam 170, a second concentric beam 180, and a third concentric beam 190, where an orthographic projection of the third concentric beam 190 may be encircled by an orthographic projection the second concentric beam 180 in a plane formed by the x- and y-axes and where the orthographic projection of the second concentric beam 180 may be encircled by an orthographic projection of the first concentric beam 170 in the plane formed by the x- and y-axes.

In some embodiments, and as shown, each of the plurality of curved beams may be detachably coupled to each other one of the plurality of curved beams via an asterisk beam joint 109. Specifically, the asterisk beam joint 109 may be detachably coupled to each of the first curved beam 114, the second curved beam 124, and the third curved beam 154 at a shared intercept therebetween such that each of the first curved beam 114, the second curved beam 124, and the third curved beam 154 are joined to one another at the shared intercept. However, in some embodiments, the asterisk beam joint 109 may not be directly coupled to the one or more concentric beams. Further, it will be appreciated that the asterisk beam joint 109 may not be considered a pairwise beam joint, as more the asterisk beam joint may detachably couple three or more curved beams at the shared intercept. As such, in one embodiment, the plurality of beam joints may include at most eighteen pairwise beam joints in addition to the asterisk beam joint 109. In alternative embodiments, and as discussed in detail below with reference to FIGS. 12-14, each of the plurality of curved beams may be detachably coupled to each other one of the plurality of curved beams via respective pairwise beam joints.

Each of the plurality of curved beams may be detachably coupled to each of the one or more concentric beams via respective pairs of pairwise beam joints. Specifically, the first curved beam 114 may be detachably coupled to the first concentric beam 170 via pairwise beam joints 171 and 174, the second concentric beam 180 via pairwise beam joints 181 and 184, and the third concentric beam 190 via pairwise beam joints 191 and 194; the second curved beam 124 may be detachably coupled to the first concentric beam 170 via pairwise beam joints 172 and 173, the second concentric beam 180 via pairwise beam joints 182 and 183, and the third concentric beam 190 via pairwise beam joints 192 and 193; and the third curved beam 154 may be detachably coupled to the first concentric beam 170 via pairwise beam joints 175 and 176, the second concentric beam 180 via pairwise beam joints 185 and 186, and the third concentric beam 190 via pairwise beam joints 195 and 196.

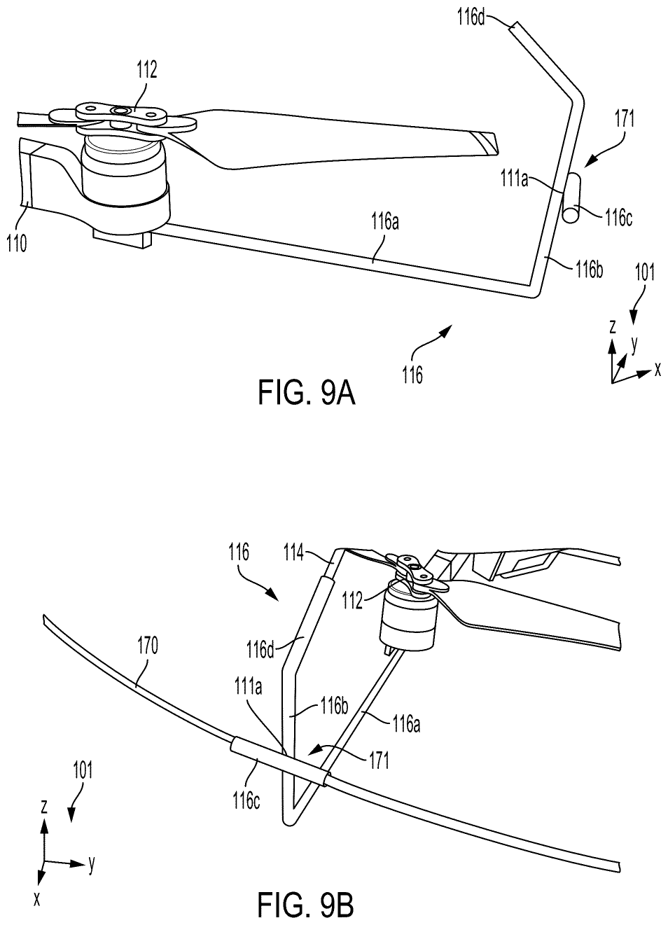

The external cage 107 may be detachably coupled to the UAV 102 at opposing ends of each of at least two of the plurality of curved beams. For example, and as shown at FIG. 1, the first curved beam 114 may be detachably coupled to the UAV 102 at opposing ends via a first coupling joint 116 and a fourth coupling joint 146 and the second curved beam 124 may be detachably coupled to the UAV 102 at opposing ends via a second coupling joint 126 and a third coupling joint 136. Specifically, the first coupling joint 116 may be affixed (detachably or otherwise) to the first arm 110, the second coupling joint 126 may be affixed (detachably or otherwise) to the second arm 120, the third coupling joint 136 may be affixed (detachably or otherwise) to the third arm 130, and the fourth coupling joint 146 may be affixed (detachably or otherwise) to the fourth arm 140. Further, and as discussed in detail below with reference to FIGS. 9A and 9B, the pairwise beam joints 171, 172, 173, and 174 may be integrally formed with the first, second, third, and fourth coupling joints 116, 126, 136, and 146, respectively.

As shown, the external cage 107 may be positioned above the UAV 102 and may at least partially enclose sides (e.g., the front side 103, the rear side 104, the port side 105, and the starboard side 106) of the UAV 102. In some examples, the external cage 107 may extend beneath a lowest component of the UAV 102 along the z-axis, while in other examples, the external cage 107 may leave an underside of the UAV 102 entirely unobstructed. For instance, in some examples, at least one of the one or more concentric beams may be positioned beneath a lowest component of the UAV 102 along the z-axis, while in other examples, none of the one or more concentric beams may be positioned beneath the UAV 102 such that the underside of the UAV 102 may be entirely unobstructed.

As further shown, the external cage 107 may be formed as a mesh carapace enclosing at least a portion of the UAV 102 (as used herein, “mesh” may refer to a grid and/or open framework including a plurality of spaces delimited by beams, wires, fibers, and/or other physical delimiters). Specifically, the mesh carapace may include a plurality of open spaces delimited by the plurality of beams. For example, each of the plurality of open spaces may be delimited by at least three of the plurality of beams. In the UAV system 100, for instance, each of the plurality of open spaces may be delimited either by two curved beams and one concentric beam or by two curved beams and two concentric beams.

By judiciously selecting a configuration of the plurality of beams and the plurality of beam joints, the external cage 107 may be specifically adapted for the obstructive environment. Specifically, in some examples, each of the plurality of open spaces may be sized so as to mitigate interference of obstructing objects (e.g., plant foliage) with the plurality of propellers of the UAV 102. Accordingly, each of the number of the beams and the number of the beam joints may be increased as an average size of obstructing objects in the obstructive environment decreases.

Referring now to FIG. 2, a perspective view depicting the UAV system 100 is shown. In some embodiments, and as shown in FIG. 2, the UAV system 100 may further include a mesh netting 108 detachably coupled to the external cage 107. Specifically, the mesh netting 108 may cover an exterior of the external cage 107, the exterior of the external cage 107 being opposite to an interior of the external cage 107 facing the UAV 102 at least partially enclosed by the external cage 107.

As shown, the mesh netting 108 may be formed from a plurality of fibers arranged in a grid and defining a grid of spaces, each space in the grid of spaces being smaller than each space in the plurality of open spaces of the mesh carapace forming the external cage. Accordingly, a mesh of the mesh netting 108 may be finer than a mesh of the mesh carapace. In this way, the mesh netting 108 may provide additional protection from relatively malleable and small obstructing objects in the obstructive environment (e.g., leaves), while the external cage 107 may provide protection from both relatively malleable objects and from larger, relatively rigid obstructing objects in the obstructive environment (e.g., branches).

As further shown, a camera 118 may be positioned on the underside of the UAV 102. In some examples, the camera 118, along with other components of the UAV 102 affixed to the underside thereof, may be unobstructed by the external cage 107, such that various functionalities of the UAV 102 may be maintained without practical limitation.

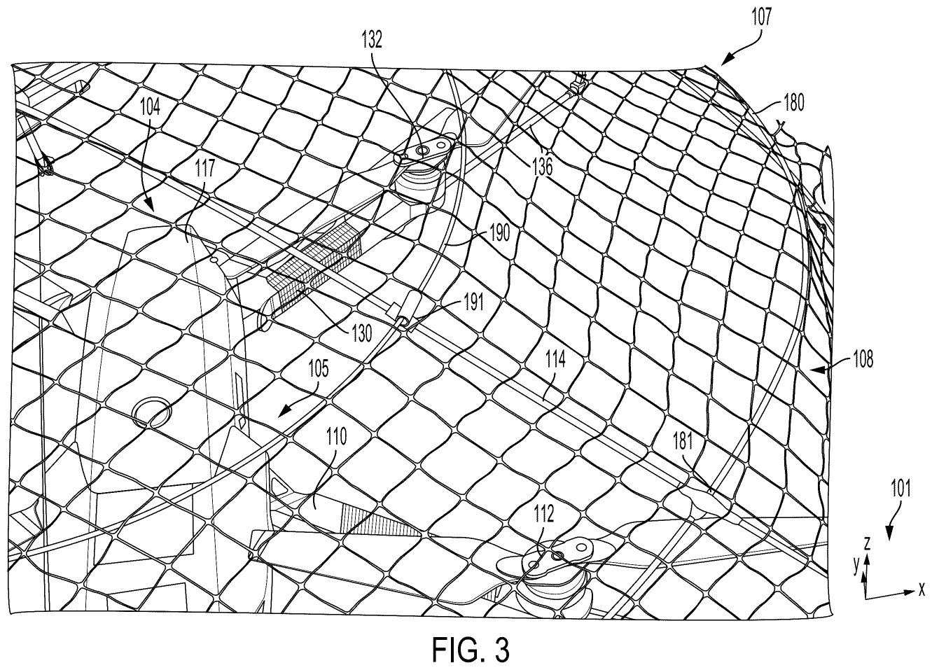

Referring now to FIG. 3, an enlarged view depicting the UAV system 100 is shown. A relative sizing of the grid of spaces defined by the plurality of fibers of the mesh netting 108 compared to a relative sizing of the plurality of open spaces delimited by the plurality of beams of the external cage 107 may be particularly apparent.

Referring now to FIGS. 4-8, exemplary steps of an assembly process for the first embodiment of the UAV system (e.g., 100) are shown. Specifically, the external cage (e.g., 107) of the UAV system may correspond to a modular configuration, assemblable from the plurality of beams and the plurality of beam joints in a variety of configurations respectively suited for specific applications in specific obstructive environments. In this way, the external cage may be adapted for a given operation of the UAV system according to given conditions and application.

Referring now to FIG. 4, a first exemplary step of the assembly process for the first embodiment of the UAV system (e.g., 100) is schematically depicted. The first, third, and fourth coupling joints 116, 136, and 146 are shown detachably coupled to the first, third, and fourth arms 110, 130, and 140 of the UAV 102, respectively, while the second coupling joint 126 has yet to be coupled to the second arm 120. The pairwise beam joints 172, 173, and 174 are further shown integrally formed with the second, third, and fourth coupling joints 126, 136, and 146, respectively.

Referring now to FIG. 5, a second exemplary step of the assembly process for the first embodiment of the UAV system (e.g., 100) is schematically depicted. Following the first exemplary step of FIG. 4, the second coupling joint 126 may be detachably coupled to the second arm 120 of the UAV 102. The pairwise beam joints 171, 172, 173, and 174 are further shown integrally formed with the first, second, third, and fourth coupling joints 116, 126, 136, and 146, respectively. Three of the plurality of beams are further shown detachably coupled via the asterisk beam joint 109 and not yet coupled to the UAV 102 (e.g., via the first, second, third, and fourth coupling joints 116, 126, 136, and 146).

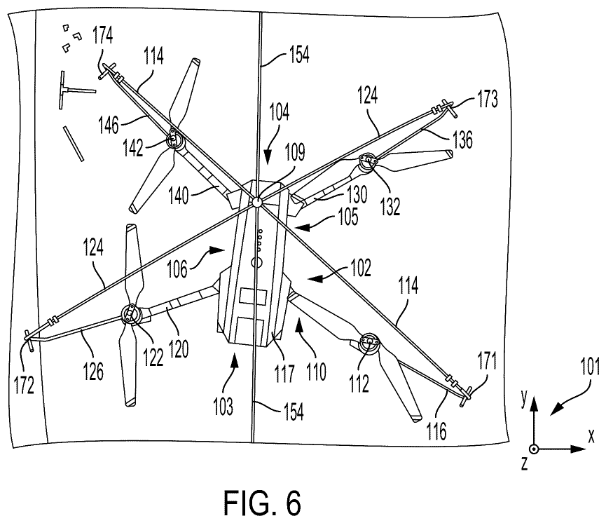

Referring now to FIG. 6, a third exemplary step of the assembly process for the first embodiment of the UAV system (e.g., 100) is schematically depicted. Following the second exemplary step of FIG. 5, two of the beams detachably coupled via the asterisk beam joint 109 may be curved via detachable coupling to the first, second, third, and fourth coupling joints 116, 126, 136, and 146. In this way, the first curved beam 114 may be formed (e.g., positioned and curved) and detachably coupled to the UAV 102 via the first and fourth coupling joints 116 and 146 (e.g., via the pairwise beam joints 171 and 174 respectively integrally formed therewith) and the second curved beam 124 may be formed (e.g., positioned and curved) and detachably coupled to the UAV 102 via the second and third coupling joints 126 and 136 (e.g., via the pairwise beam joints 172 and 173 respectively integrally formed therewith).

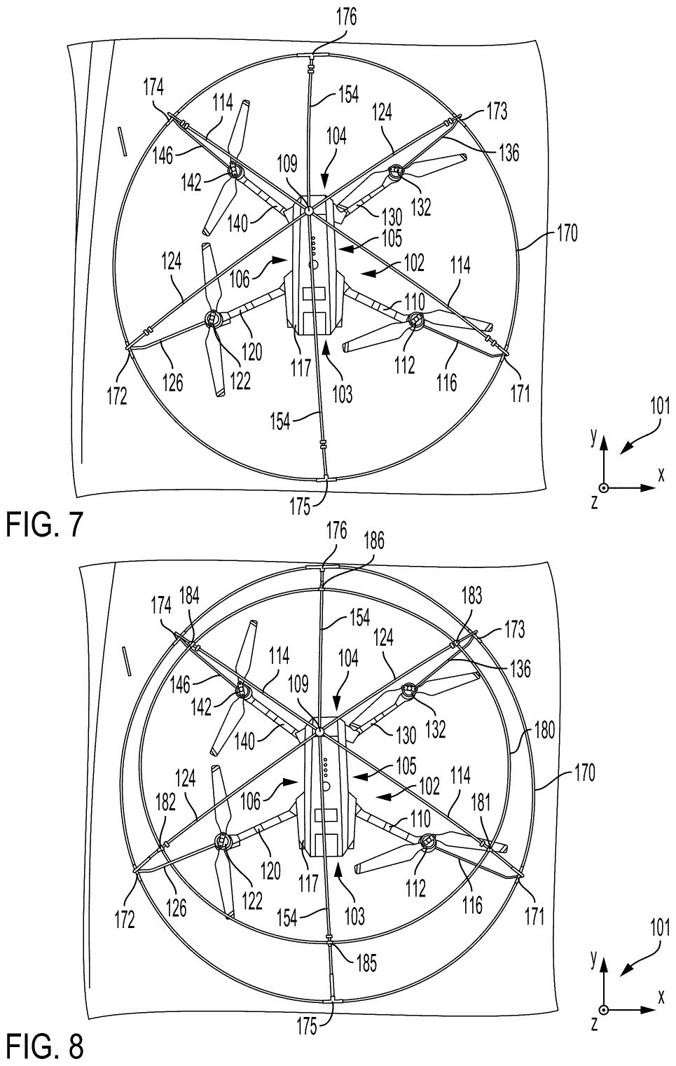

Referring now to FIG. 7, a fourth exemplary step of the assembly process for the first embodiment of the UAV system (e.g., 100) is schematically depicted. Following the third exemplary step of FIG. 6, and as shown at FIG. 7, the first concentric beam 170 may be detachably coupled to the first curved beam 114 via the pairwise beam joints 171 and 174 and to the second curved beam 124 via the pairwise beam joints 172 and 173. The third curved beam 154 may further be formed (e.g., positioned and curved) and detachably coupled to the first concentric beam 170 via the pairwise beam joints 175 and 176.

Referring now to FIG. 8, a fifth exemplary step of the assembly process for the first embodiment of the UAV system (e.g., 100) is schematically depicted. Following the fourth exemplary step of FIG. 7, and as shown at FIG. 8, the second concentric beam 180 may be detachably coupled to the first curved beam 114 via the pairwise beam joints 181 and 184, to the second curved beam 124 via the pairwise beam joints 182 and 183, and to the third curved beam 154 via the pairwise beam joints 185 and 186.

Following the fifth exemplary step of FIG. 8, the third concentric beam (e.g., 190; not shown at FIGS. 4-8) may be coupled to the first curved beam 114 via two pairwise beam joints (e.g., 191 and 194; not shown at FIGS. 4-8), to the second curved beam 124 via two pairwise beam joints (e.g., 192 and 193; not shown at FIGS. 4-8), and to the third curved beam 154 via two pairwise beam joints (e.g., 195 and 196; not shown at FIGS. 4-8).

Referring now to FIGS. 9A and 9B, first and second enlarged views depicting the first coupling joint 116 are respectively shown. Specifically, the first coupling joint 116 may be formed from mounting tubes 116a, 116b, 116c, and 116d adhered to one another via welding or an adhesive 111a (e.g., glue, tape, wire, fibers, or a combination thereof). As shown, an end of the mounting tube 116a may be detachably coupled to the first arm 110 of the UAV (e.g., 102) and an opposite end of the mounting tube 116a may be adhered to an end of the mounting tube 116b at an angle of approximately 90°. A central portion of the mounting tube 116b may be adhered to a central portion of the mounting tube 116c at an angle of approximately 90° and an end of the mounting tube 116b opposite the end adhered to the mounting tube 116a may be adhered to an end of the mounting tube 116d at an angle of approximately 120°. The first curved beam 114 may be detachably coupled to an end of the mounting tube 116d opposite the end of the mounting tube 116d adhered to the mounting tube 116b. In this way, the pairwise beam joint 171 may be integrally formed in the first coupling joint 116, the pairwise beam joint 171 being “pairwise” in that two beams may be detachably coupled therewith: the first curved beam 114 (inserted into the mounting tube 116d) and the first concentric beam 170 (inserted through the mounting tube 116c). It will be appreciated that the second, third, and fourth coupling joints (e.g., 126, 136, and 146; not shown at FIGS. 9A and 9B) may be configured analogously to the first coupling joint 116.

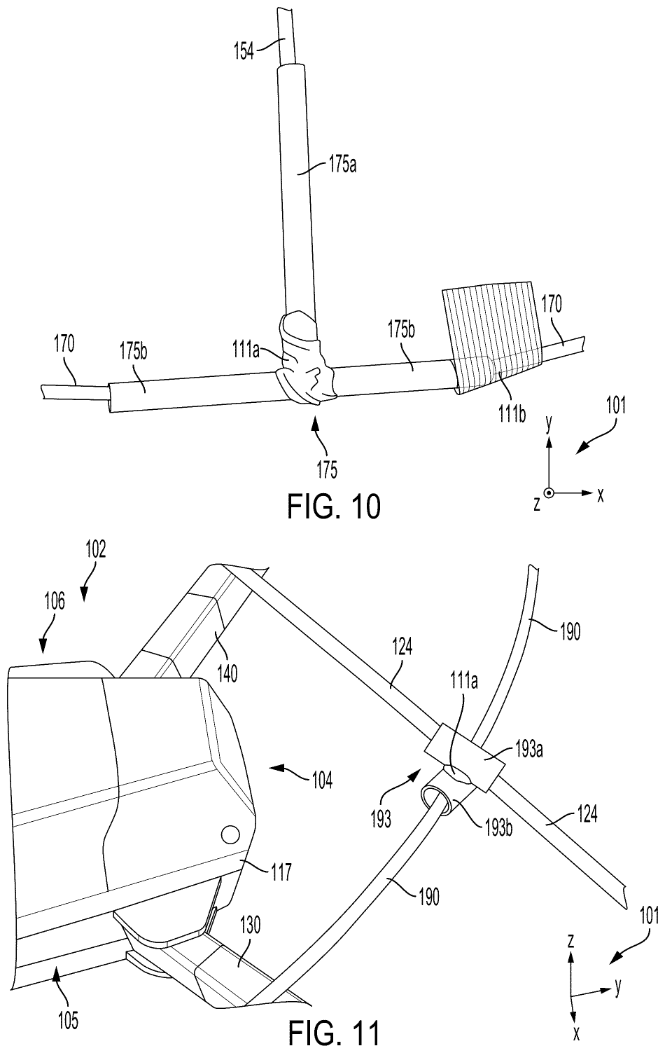

Referring now to FIG. 10, an enlarged view depicting the pairwise beam joint 175 is shown. Specifically, the pairwise beam joint 175 may be formed from mounting tubes 175a and 175b adhered to one another via welding or the adhesive 111a. As shown, the third curved beam 154 may be detachably coupled to an end of the mounting tube 175a and an opposite end of the mounting tube 175a may be adhered to a central portion of the mounting tube 175b at an angle of approximately 90°. In this way, the pairwise beam joint 175 may be configured as a “T junction,” the pairwise beam joint 175 being “pairwise” in that two beams may be detachably coupled therewith: the third curved beam 154 (inserted into the mounting tube 175a) and the first concentric beam 170 (inserted through the mounting tube 175b). In some examples, and as shown, tape 111b (or other adhesive) may further be provided to detachably secure the first concentric beam 170 to the mounting tube 175b. It will be appreciated that the other pairwise beam joint (e.g., 176; not shown at FIG. 10) detachably coupling the third curved beam 154 to the first concentric beam 170 may be configured analogously to the pairwise beam joint 175.

Referring now to FIG. 11, an enlarged view depicting the pairwise beam joint 193 is shown. Specifically, the pairwise beam joint 193 may be formed from mounting tubes 193a and 193b may be adhered to one another via welding or the adhesive 111a. As shown, a central portion of the mounting tube 193a may be adhered to a central portion of the mounting tube 193b at an angle of approximately 90°. In this way, the pairwise beam joint 193 may be configured as a crosswise shape (e.g., a “+” or an “x”), the pairwise beam joint 193 being “pairwise” in that two beams may be detachably coupled therewith: the second curved beam 124 (inserted through the mounting tube 193a) and the third concentric beam 190 (inserted through the mounting tube 193b). It will be appreciated that the other pairwise beam joints (e.g., 191, 192, 194, 195, and 196; not shown at FIG. 11) detachably coupling the curved beams to the third concentric beam 190, as well as the pairwise beam joints (e.g., 181, 182, 183, 184, 185, and 186; not shown at FIG. 11) detachably coupling the curved beams to the second concentric beam (e.g., 180; not shown at FIG. 11), may be configured analogously to the pairwise beam joint 193.

Referring now to FIG. 12, a perspective view depicting a second embodiment of a UAV system 200 is shown, the UAV system 200 including an external cage 207 affixed to a UAV 202. A set of reference axes 201 is provided for describing relative positioning of the components shown, the axes 201 indicating an x-axis, a y-axis, and a z-axis. In one example, the z-axis may be parallel with a direction of gravity and a vertical direction, the x-axis parallel with a horizontal (e.g., lateral) direction, and the y-axis parallel with a transverse (e.g., longitudinal) direction of the UAV 202. During operation, the UAV 202 may be considered to move, with respect to the axes 201, upwards along the z-axis in a positive direction, downwards along the z-axis in a negative direction, leftwards along the x-axis in a positive direction, rightwards along the x-axis in a negative direction, backwards along the y-axis in a positive direction, and forwards along the y-axis in a negative direction.

It will be appreciated that components of the UAV system 200 having largely similar function to the UAV system 100 may be labeled with corresponding numbers, prefixed with a “2” instead of a “1.” For example, the UAV 202 may have a similar function to the UAV 102. Accordingly, only additional features or those features of the UAV system 200 having significant configurational distinctions from corresponding features of the UAV system 100 may be described in detail below; description of all other features of the UAV system 200 may be supplemented by description of the corresponding features as provided in detail above with reference to FIGS. 1-11.

As shown at FIG. 12, UAV 202 may include a plurality of propeller guards detachably affixed to and extending from beneath a plurality of propellers. Specifically, a first propeller guard 213 may be detachably affixed to undersides of second and fourth propellers 222 and 242 and a second propeller guard 215 may be detachably affixed to undersides of first and third propellers 212 and 232. Further, the external cage 207 may be detachably coupled to the first propeller guard 213 via second, fourth, and fifth connectors 262, 264, and 265, and to the second propeller guard via first, third, and sixth connectors 261, 263, and 266. In some examples, the fifth connector 265 may be detachably coupled to the first propeller guard 213 via an auxiliary connector 245, the auxiliary connector 245 further detachably coupled to each of the fifth connector 265 and the first propeller guard 213 via a strap or adhesive 255. Similarly, in some examples, the sixth connector 266 may be detachably coupled to the second propeller guard 215 via an auxiliary connector 246, the auxiliary connector 246 further detachably coupled to each of the sixth connector 266 and the second propeller guard 215 via a strap or adhesive 256.

As shown, each of a first curved beam 214 and a first concentric beam 270 may be detachably coupled to each of the first and fourth connectors 261 and 264 via pairwise beam joints 271 and 274, respectively. Further, each of a second curved beam 224 and the first concentric beam 270 may be detachably coupled to each of the second and third connectors 262 and 263 via pairwise beam joints 272 and 273, respectively. Further, each of a third curved beam 254 and the first concentric beam 270 may be detachably coupled to each of the fifth and sixth connectors 265 and 266 via pairwise beam joints 275 and 276, respectively.

Rotation of the plurality of propellers of the UAV 202 may define respective circles, where centers of the circles may respectively coincide with axes of rotation of the plurality of propellers and diameters of the circles may respectively coincide with pairwise blade lengths of the plurality of propellers. In some examples, and as shown, the plurality of propeller guards may extend outwardly from circumferences of the circles respectively defined by rotation of the plurality of propellers. In some examples, and as further shown, the external cage 207 may be detachably coupled to each of the plurality of propeller guards outside of the circumferences in a plane defined by the x- and y-axes.

In some examples, each of the plurality of curved beams may be detachably coupled to each other of the plurality of curved beams via a respective pairwise beam joint. Specifically, the first curved beam 214 may be detachably coupled to the third curved beam 254 via a pairwise beam joint 209a, the first curved beam 214 may be detachably coupled to the second curved beam 224 via a pairwise beam joint 209b, and the second curved beam 224 may be detachably coupled to the third curved beam 254 via a pairwise beam joint 209c. As such, in some embodiments (such as in the UAV system 200), no asterisk beam joint may be included.

Referring now to FIG. 13, a perspective view depicting a third embodiment of a UAV system 300 is shown, the UAV system 300 including an external cage 307 affixed to a UAV 302. A set of reference axes 301 is provided for describing relative positioning of the components shown, the axes 301 indicating an x-axis, a y-axis, and a z-axis. In one example, the z-axis may be parallel with a direction of gravity and a vertical direction, the x-axis parallel with a horizontal (e.g., lateral) direction, and the y-axis parallel with a transverse (e.g., longitudinal) direction of the UAV 302. During operation, the UAV 302 may be considered to move, with respect to the axes 301, upwards along the z-axis in a positive direction, downwards along the z-axis in a negative direction, leftwards along the x-axis in a positive direction, rightwards along the x-axis in a negative direction, backwards along the y-axis in a positive direction, and forwards along the y-axis in a negative direction.

It will be appreciated that components of the UAV system 300 having largely similar function to the UAV systems 100 and 200 may be labeled with corresponding numbers, prefixed with a “3” instead of a “1” or a “2.” For example, the UAV 302 may have a similar function to the UAVs 102 and 202. Accordingly, only additional features or those features of the UAV system 300 having significant configurational distinctions from corresponding features of the UAV systems 100 and 200 may be described in detail below; description of all other features of the UAV system 300 may be supplemented by description of the corresponding features as provided in detail above with reference to FIGS. 1-12.

As shown, pairwise beam joints 371, 372, 373, and 374 may be respectively integrally formed in first, second, third, and fourth connectors 361, 362, 363, and 364. Specifically, the pairwise beam joint 371 may be formed as three holes in the first connector 361 detachably coupling a first curved beam 314 (e.g., the first curved beam 314 may be securely fit into one of the three holes formed in the first connector 361) to a first concentric beam 370 (e.g., the first concentric beam 370 may be securely fit into a remaining two of the three holes formed in the first connector 361). Further, the pairwise beam joint 372 may be formed as three holes in the second connector 362 detachably coupling a second curved beam 324 (e.g., the second curved beam 324 may be securely fit into one of the three holes formed in the second connector 362) to the first concentric beam 370 (e.g., the first concentric beam 370 may be securely fit into a remaining two of the three holes formed in the second connector 362). Further, the pairwise beam joint 373 may be formed as three holes in the third connector 363 detachably coupling the second curved beam 324 (e.g., the second curved beam 324 may be securely fit into one of the three holes formed in the third connector 363) to the first concentric beam 370 (e.g., the first concentric beam 370 may be securely fit into a remaining two of the three holes formed in the third connector 363). Further, the pairwise beam joint 374 may be formed as three holes in the fourth connector 364 detachably coupling the first curved beam 314 (e.g., the first curved beam 314 may be securely fit into one of the three holes formed in the fourth connector 364) to the first concentric beam 370 (e.g., the first concentric beam 370 may be securely fit into a remaining two of the three holes formed in the fourth connector 364).

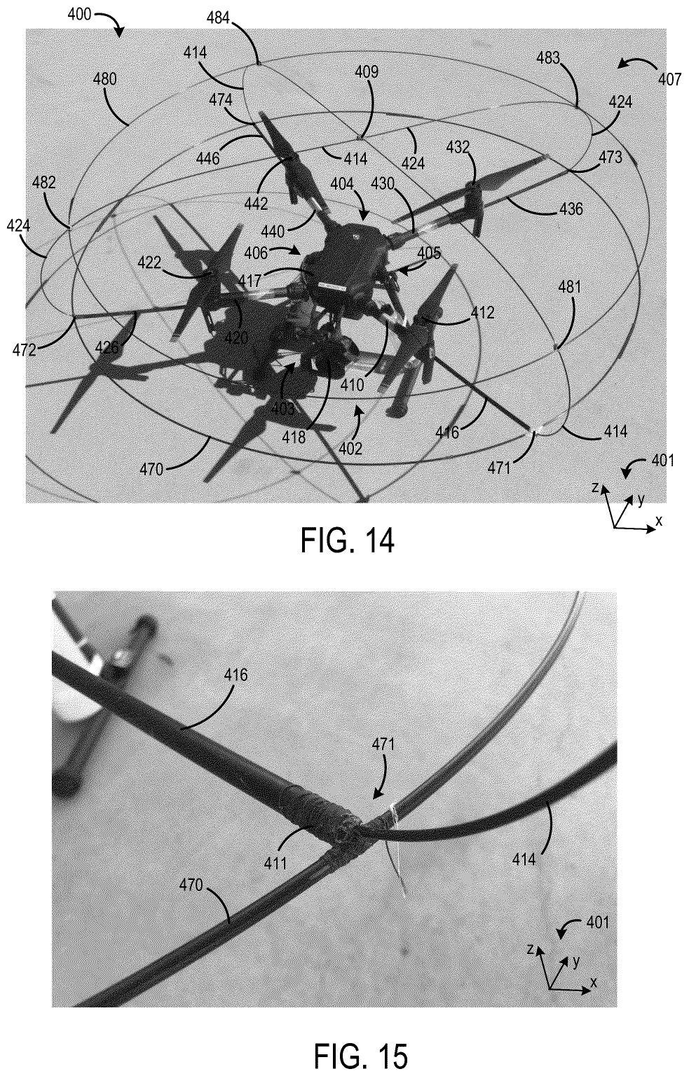

Referring now to FIGS. 14 and 15, a fourth embodiment of a UAV system 400 is depicted, the UAV system 400 including an external cage 407 affixed to a UAV 402. Accordingly, components with similar configurations depicted variously among FIGS. 14 and 15 may be labeled with corresponding numbers (e.g., a first curved beam may be labeled with “414” with respect to FIGS. 14 and 15). Further, individual components may be introduced and described below with reference to a figure in which such components first appear (e.g., the first curved beam 414 may be introduced and described with reference to FIG. 14), and may or may not be supplemented with further description thereafter. A set of reference axes 401 is provided for describing relative positioning of the components shown and for comparison between the views of FIGS. 14 and 15, the axes 401 indicating an x-axis, a y-axis, and a z-axis. In one example, the z-axis may be parallel with a direction of gravity and a vertical direction, the x-axis parallel with a horizontal (e.g., lateral) direction, and the y-axis parallel with a transverse (e.g., longitudinal) direction of the UAV 402. During operation, the UAV 402 may be considered to move, with respect to the axes 401, upwards along the z-axis in a positive direction, downwards along the z-axis in a negative direction, leftwards along the x-axis in a positive direction, rightwards along the x-axis in a negative direction, backwards along the y-axis in a positive direction, and forwards along the y-axis in a negative direction.

It will be appreciated that components of the UAV system 400 having largely similar function to the UAV systems 100, 200, and 300 may be labeled with corresponding numbers, prefixed with a “4” instead of a “1,” a “2,” or a “3.” For example, the UAV 402 may have a similar function to the UAVs 102, 202, and 302. Accordingly, only additional features or those features of the UAV system 400 having significant configurational distinctions from corresponding features of the UAV systems 100, 200, and 300 may be described in detail below; description of all other features of the UAV system 400 may be supplemented by description of the corresponding features as provided in detail above with reference to FIGS. 1-13.

Referring now to FIG. 14, a perspective view depicting the UAV system 400 is shown. As shown, in some examples orthographic projections of at least two concentric beams in a plane defined by the x- and y-axes may overlap one another. Specifically, an orthographic projection of a second concentric beam 480 in the plane defined by the x- and y-axes may overlap with an orthographic projection of a first concentric beam 470 in the plane defined by the x- and y-axes. The first concentric beam 470 may be positioned beneath the second concentric beam 480 along the z-axis, such that the first concentric beam 470 may be detachably coupled to first, second, third, and fourth coupling joints 416, 426, 436, and 446 via pairwise beam joints 471, 472, 473, and 474, respectively.

As further shown, a first curved beam 414 may be detachably coupled to a second curved beam 424 via a pairwise beam joint 409. Though only two curved beams are shown in FIG. 14, it will be appreciated that, in some examples, the UAV system 400 may include more than two curved beams detachably coupled at a shared intercept. In such examples, the pairwise beam joint 409 may be considered an asterisk beam joint 409 and similarly configured to the asterisk beam joint 109 as discussed in detail above with reference to FIG. 1.

Referring now to FIG. 15, an enlarged view depicting the pairwise beam joint 171 is shown. Specifically, the pairwise beam joint 171 may be formed from an adhesive 411 (e.g., glue, tape, wire, fibers, or a combination thereof). As shown, the pairwise beam joint 471 may detachably couple each of the first curved beam 414, the first concentric beam 470, and the first coupling joint 416 to one another. As such, in some examples, the pairwise beam joint 471 may be formed independently of the first coupling joint 416. In such examples, the pairwise beam joint 471 may nonetheless be considered “pairwise” in that two beams may be detachably coupled therewith: the first curved beam 414 and the first concentric beam 470. It will be appreciated that the other pairwise beam joint (e.g., 474; not shown at FIG. 15) detachably coupling each of the first curved beam 414, the first concentric beam 470, and the fourth coupling joint (e.g., 446; not shown at FIG. 15) to one another, as well as each of the second curved beam (e.g., 424; not shown at FIG. 15), the first concentric beam 470, and respective coupling joints (e.g., second and third coupling joints 472 and 473; not shown at FIG. 15) to one another, may be configured analogously to the pairwise beam joint 471.

Referring now to FIG. 16, a flow chart depicting a method 1600 for assembling and operating a UAV system in an obstructive environment (e.g., plant foliage harboring an avian habitat) is shown. In some examples, the UAV system may be one of the UAV system 100 as described in detail above with reference to FIGS. 1-11, the UAV system 200 as described in detail above with reference to FIG. 12, the UAV system 300 as described in detail above with reference to FIG. 13, and the UAV system 400 as described in detail above with reference to FIGS. 14 and 15, or the UAV system may include a combination of features, elements, and components from the UAV systems 100, 200, 300, and 400. Accordingly, the UAV system may include an external cage removably affixed to a UAV, the external cage being formed as a mesh carapace maintaining uninterrupted rotation of propellers of the UAV when an obstructing object in the obstructive environment contacts the mesh carapace.

In some examples, the mesh carapace may be assembled from a plurality of beams removably joined via a plurality of joints. Accordingly, the external cage may have a modular construction, wherein each of a number of the plurality of beams and the plurality of joints may be increased as an average size of obstructing objects in the obstructive environment decreases. Additionally or alternatively, a mesh netting may be removably affixed to the mesh carapace, such that the mesh netting may cover an exterior of the mesh carapace, the exterior being opposite to an interior of the mesh carapace facing the UAV. In one example, a mesh of the mesh netting may be finer than a mesh of the mesh carapace. In this way, the mesh of the mesh carapace forming the external cage may be adapted for a specific obstructive environment.

At 1602, method 1600 may include assembling and removably affixing the external cage (e.g., formed as the mesh carapace) to the UAV, the external cage being positioned above and at sides of the UAV. Specifically, the mesh carapace forming the external cage may be assembled as a first mesh adapted for a first operation in a first obstructive environment. In some examples, the external cage may be affixed such that an underside of the UAV may be left partially or wholly unobstructed by the external cage.

At 1604, the UAV may be operated in the first obstructive environment for the first operation (e.g., monitoring a first avian habitat in first plant foliage). When a first obstructing object in the first obstructing environment contacts the mesh carapace, rotation of the propellers of the UAV may be maintained and uninterrupted.

At 1606, method 1600 may include determining whether the first operation is completed. For example, the first operation may be considered completed when the UAV is no longer operating in the first obstructive environment. If the first operation is determined to not yet be completed, method 1600 may proceed to 1608, where method 1600 may include continuing the first operation. Method 1600 may return to 1604.

If the first operation is determined to be completed, method 1600 may proceed to 1610, where method 1600 may include disassembling and removing the external cage from the UAV (e.g., after the UAV is no longer operating). The UAV may then be operated again without the external cage, or the UAV may remain inoperative for a duration (e.g., until the external cage is reaffixed to the UAV).

At 1612, method 1600 may include reassembling and removably reaffixing the external cage to the UAV, the external cage being positioned above and at sides of the UAV. Specifically, the mesh carapace forming the external cage may be assembled as a second mesh adapted for a second operation in a second obstructive environment. In one example, the second mesh may be finer than the first mesh. In some examples, the external cage may be reaffixed such that an underside of the UAV may be left partially or wholly unobstructed by the external cage.

At 1614, the UAV may be operated in the second obstructive environment for the second operation (e.g., monitoring a second avian habitat in second plant foliage). When a second obstructing object in the second obstructing environment contacts the mesh carapace, rotation of the propellers of the UAV may be maintained and uninterrupted.

At 1616, method 1600 may include determining whether the second operation is completed. For example, the second operation may be considered completed when the UAV is no longer operating in the second obstructive environment. If the second operation is determined to not yet be completed, method 1600 may proceed to 1618, where method 1600 may include continuing the second operation. Method 1600 may return to 1614.

If the first operation is determined to be completed, method 1600 may return.

Referring now to FIG. 17, a schematic diagram 1700 depicting exemplary operation of a UAV system 1702 is shown. In some examples, the UAV system 1702 may be one of the UAV system 100 as described in detail above with reference to FIGS. 1-11, the UAV system 200 as described in detail above with reference to FIG. 12, the UAV system 300 as described in detail above with reference to FIG. 13, and the UAV system 400 as described in detail above with reference to FIGS. 14 and 15, or the UAV system may include a combination of features, elements, and components from the UAV systems 100, 200, 300, and 400. Accordingly, the UAV system 1702 may include an external cage removably affixed to a UAV, the external cage being formed as a mesh carapace maintaining uninterrupted rotation of propellers of the UAV when an obstructing object in the obstructive environment contacts the mesh carapace.

A set of reference axes 1701 is provided for describing relative positioning of the components shown, the axes 1701 indicating an x-axis, a y-axis, and a z-axis. In one example, the z-axis may be parallel with a direction of gravity and a vertical direction, the x-axis parallel with a horizontal (e.g., lateral) direction, and the y-axis parallel with a transverse (e.g., longitudinal) direction of the UAV system 1702. During operation, the UAV system 1702 may be considered to move, with respect to the axes 1701, upwards along the z-axis in a positive direction, downwards along the z-axis in a negative direction, leftwards along the x-axis in a positive direction, rightwards along the x-axis in a negative direction, backwards along the y-axis in a positive direction, and forwards along the y-axis in a negative direction.

As shown, the UAV system 1702 may operate in an obstructive environment. For example, the UAV system 1702 may fly above a ground 1704 in a vicinity of plant foliage 1703. During a first exemplary operation 1710, the UAV system 1702 may fly underneath and around the plant foliage 1703 without contacting the plant foliage 1703; thus, flight of the UAV system 1702 may be maintained during the first exemplary operation 1710. During a second exemplary operation 1720, the UAV system 1702 may fly above and around the plant foliage 1703 without contacting the plant foliage 1703; thus, flight of the UAV system 1702 may be maintained during the second exemplary operation 1720. During a third exemplary operation 1730, the UAV system 1702 may fly directly toward the plant foliage 1703 such that the mesh carapace of the UAV system 1702 contacts the plant foliage and prevents the plant foliage 1703 from interfering with rotation of the propellers of the UAV system 1702; thus, flight of the UAV system 1702 may be maintained during the third exemplary operation 1730. In this way, regardless of whether the UAV system 1702 contacts the plant foliage 1703, operation of the UAV system 1702 may be maintained.

In this way, an external cage is provided for maintaining operation of an unmanned aerial vehicle (UAV) in an obstructive environment. In some examples, the external cage may have a lightweight, modular construction. For example, the external cage may be assembled from a plurality of beams joined together via a plurality of removable joints, at least the plurality of beams being fabricated from a lightweight material, such as fiberglass or carbon fiber. A configuration of the plurality of beams and the plurality of removable joints may be selected specific to the obstructive environment. For instance, a mesh of the external cage may be made finer by increasing a number of the plurality of beams and a number of the plurality of removable joints responsive to a decreasing average size of obstructing objects in the obstructive environment. Additionally or alternatively, the external cage may leave an underside of the UAV unencumbered during flight. A technical effect of the lightweight, modular construction is that the external cage may be adapted to protect the UAV in varying environments and under varying conditions without limiting flight and other operations of the UAV.

In one example, an unmanned aerial vehicle, comprising: a plurality of propellers; a plurality of propeller guards affixed to the plurality of propellers; and a cage positioned adjacent to the plurality of propellers, the cage constructed from a plurality of beams detachably joined together via a plurality of crossed mounting tubes, and the cage detachably coupled to each of the plurality of propeller guards. A first example of the unmanned aerial vehicle further includes wherein the plurality of propeller guards extends from beneath the plurality of propellers, the plurality of propeller guards being affixed to undersides of the plurality of propellers. A second example of the unmanned aerial vehicle, optionally including the first example of the unmanned aerial vehicle, further includes wherein the plurality of propeller guards extends outwardly from circumferences of circles respectively defined by rotation of the plurality of propellers, centers of the circles respectively coinciding with axes of rotation of the plurality of propellers and diameters of the circles respectively coinciding with pairwise blade lengths of the plurality of propellers, and wherein the cage is detachably coupled to each of the plurality of propeller guards outside of the circumferences.

In another example, a system for an unmanned aerial vehicle, the system comprising: an external cage, comprising: a plurality of curved beams; a plurality of removable pairwise beam joints coupled to the plurality of curved beams; and one or more concentric beams joined to the plurality of curved beams via the plurality of removable pairwise beam joints; wherein the external cage is detachably coupleable to the unmanned aerial vehicle at opposing ends of each of at least two of the plurality of curved beams. A first example of the system further includes wherein the plurality of curved beams comprises at most three curved beams, wherein the one or more concentric beams comprises at most three concentric beams, and wherein the plurality of removable pairwise beam joints comprises at most eighteen removable pairwise beam joints. A second example of the system, optionally including the first example of the system, further comprises a removable asterisk beam joint coupled to each of the plurality of curved beams at a shared intercept of the plurality of curved beams such that each of the plurality of curved beams are joined to one another at the shared intercept, wherein the removable asterisk beam joint is not directly coupled to the one or more concentric beams. A third example of the system, optionally including one or more of the first and second examples of the system, further includes wherein each of the plurality of curved beams are coupled to each other of the plurality of curved beams via a respective one of the plurality of removable pairwise beam joints. A fourth example of the system, optionally including one or more of the first through third examples of the system, further includes wherein the external cage is formed as a mesh carapace enclosing at least a portion of the unmanned aerial vehicle. A fifth example of the system, optionally including one or more of the first through fourth examples of the system, further includes wherein the mesh carapace comprises a plurality of open spaces delimited by the plurality of curved beams and the one or more concentric beams. A sixth example of the system, optionally including one or more of the first through fifth examples of the system, further includes wherein each of the plurality of open spaces is delimited by at least three beams from a group consisting of the plurality of curved beams and the one or more concentric beams. A seventh example of the system, optionally including one or more of the first through sixth examples of the system, further includes wherein each of the plurality of open spaces is sized so as to mitigate interference of foliage with propellers of the unmanned aerial vehicle. An eighth example of the system, optionally including one or more of the first through seventh examples of the system, further comprises netting affixed to and covering the external cage, where fibers of the netting define a grid of spaces, each space in the grid of spaces being smaller than each space of the plurality of open spaces. A ninth example of the system, optionally including one or more of the first through eighth examples of the system, further includes wherein the external cage is positioned above the unmanned aerial vehicle and at least partially encloses sides of the unmanned aerial vehicle. A tenth example of the system, optionally including one or more of the first through ninth examples of the system, further includes wherein the one or more concentric beams is not positioned beneath the unmanned aerial vehicle. An eleventh example of the system, optionally including one or more of the first through tenth examples of the system, further includes wherein each of the plurality of curved beams and the one or more concentric beams is formed from carbon fiber or fiberglass.

In yet another example, a method for an unmanned aerial vehicle, the method comprising: affixing a mesh carapace to the unmanned aerial vehicle, the mesh carapace positioned above and at sides of the unmanned aerial vehicle; and operating the unmanned aerial vehicle in an obstructive environment, wherein the mesh carapace is assembled from a plurality of beams removably joined via a plurality of joints, and wherein the mesh carapace maintains uninterrupted rotation of propellers of the unmanned aerial vehicle when an obstructing object in the obstructive environment contacts the mesh carapace. A first example of the method further includes wherein each of a number of the plurality of beams and a number of joints is increased as an average size of obstructing objects in the obstructive environment decreases. A second example of the method, optionally including the first example of the method, further includes wherein the obstructive environment comprises plant foliage harboring an avian habitat. A third example of the method, optionally including one or more of the first and second examples of the method, further comprises affixing a mesh netting to the mesh carapace, the mesh netting covering an exterior of the mesh carapace, the exterior being opposite to an interior of the mesh carapace facing the unmanned aerial vehicle, and a mesh of the mesh netting being finer than a mesh of the mesh carapace. A fourth example of the method, optionally including one or more of the first through third examples of the method, further comprises, following operation of the unmanned aerial vehicle: removing the mesh carapace from the unmanned aerial vehicle; disassembling the mesh carapace by separating the plurality of beams from the plurality of joints; and prior to subsequent operation of the unmanned aerial vehicle: reassembling the mesh carapace from the plurality of beams and the plurality of joints; and reaffixing the reassembled mesh carapace to the unmanned aerial vehicle.

FIGS. 1-15 show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

In some example, an approach includes connecting the cages either to drone arms and/or landing gear. A variety of diameters of rods may be used as structural components. There may be a trade-off between cage flexibility (for shock absorption), and rigidity, (to maintain good control and aerodynamic behavior). In an example, the cages may be applied to egg oiling to ravens eggs in the interest of wildlife conservation. These nests are in complex cliff-side locations and on large utility towers. Egg oiling work is sometimes conducted in winds up to 25 mph. Carapace rotor cages allow very close approach to both the cliff faces and the metal or wood components of utility transmission towers. Their presence can allow continued operation in otherwise prohibitively strong and gusty winds by providing insurance against shat would otherwise be catastrophic collisions between rotors and these surfaces.

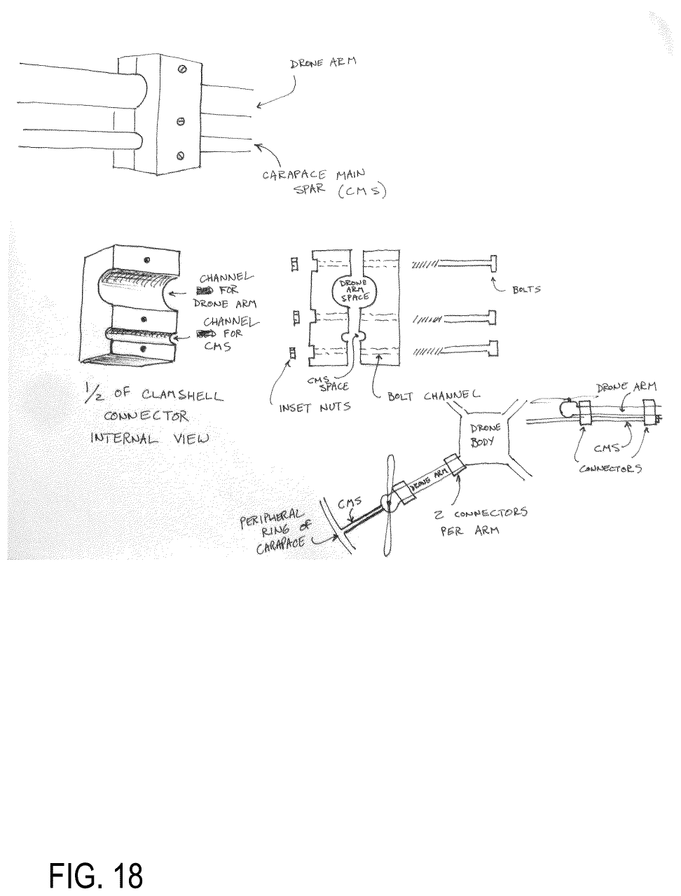

FIG. 18 shows an example connector that may be used as a connection point between the drone and the carapace. In an example, the connector may connect a beam of the cage to an arm of the UAV/Drone. The connectors may align a horizontal “Carapace Main Spar” (CMS) with a drone arm (DA) and hold it in place. The alignment may provide for parallel alignment between the beam and the drone arm. In an example, one or more (e.g., exactly two) connectors may be used on every drone arm; one at the arm's base, nearest the drone body and one at the distal end, near the drone motor/rotor combination.

As shown in FIG. 18, the connector may clasp both the DA and CMS in a clamshell design, with one or more bolts coupling the two halves together in a removable fashion. Each half of the clamshell includes two parallel channels: on for the DA and one for the CMS. Three through holes (top, middle and bottom) run through the two halves, and align to allow insertion of the three small bolts that bind the halves together. At the end of each of these tunnels is inserted a small nut, through which the bolt is threaded. Other attachment between the halves may be used, such as more or less bolts, screws, clips, catches, etc.

In an example, a small cap may be attached to the end of the CMS and adjacent to the connector. Being of a larger diameter than the CMS channel cut through the connector, it prevents the CMS from sliding through the channel, thus holding it in place longitudinally.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An unmanned aerial vehicle, comprising:
a plurality of propellers;
a plurality of propeller guards affixed to the plurality of propellers; and
a cage positioned adjacent to the plurality of propellers, the cage constructed from a plurality of beams detachably joined together via a plurality of crossed mounting tubes, and the cage detachably coupled to each of the plurality of propeller guards.

2. The unmanned aerial vehicle of claim 1, wherein the plurality of propeller guards extends from beneath the plurality of propellers, the plurality of propeller guards being affixed to undersides of the plurality of propellers.

3. The unmanned aerial vehicle of claim 2, wherein the plurality of propeller guards extends outwardly from circumferences of circles respectively defined by rotation of the plurality of propellers, centers of the circles respectively coinciding with axes of rotation of the plurality of propellers and diameters of the circles respectively coinciding with pairwise blade lengths of the plurality of propellers, and
wherein the cage is detachably coupled to each of the plurality of propeller guards outside of the circumferences.

4. A system for an unmanned aerial vehicle, the system comprising:
an external cage, comprising:
a plurality of curved beams;
a plurality of removable pairwise beam joints coupled to the plurality of curved beams; and
one or more concentric beams joined to the plurality of curved beams via the plurality of removable pairwise beam joints;
wherein the external cage is detachably coupleable to the unmanned aerial vehicle at opposing ends of each of at least two of the plurality of curved beams.

5. The system of claim 4, wherein the plurality of curved beams comprises at most three curved beams,
wherein the one or more concentric beams comprises at most three concentric beams, and
wherein the plurality of removable pairwise beam joints comprises at most eighteen removable pairwise beam joints.

6. The system of claim 4, further comprising a removable asterisk beam joint coupled to each of the plurality of curved beams at a shared intercept of the plurality of curved beams such that each of the plurality of curved beams are joined to one another at the shared intercept,
wherein the removable asterisk beam joint is not directly coupled to the one or more concentric beams.

7. The system of claim 4, wherein each of the plurality of curved beams are coupled to each other of the plurality of curved beams via a respective one of the plurality of removable pairwise beam joints.

8. The system of claim 4, wherein the external cage is formed as a mesh carapace enclosing at least a portion of the unmanned aerial vehicle.

9. The system of claim 8, wherein the mesh carapace comprises a plurality of open spaces delimited by the plurality of curved beams and the one or more concentric beams.

10. The system of claim 9, wherein each of the plurality of open spaces is delimited by at least three beams from a group consisting of the plurality of curved beams and the one or more concentric beams.

11. The system of claim 9, wherein each of the plurality of open spaces is sized so as to mitigate interference of foliage with propellers of the unmanned aerial vehicle.

12. The system of claim 9, further comprising netting affixed to and covering the external cage, where fibers of the netting define a grid of spaces, each space in the grid of spaces being smaller than each space of the plurality of open spaces.

13. The system of claim 4, wherein the external cage is positioned above the unmanned aerial vehicle and at least partially encloses sides of the unmanned aerial vehicle.

14. The system of claim 13, wherein the one or more concentric beams is not positioned beneath the unmanned aerial vehicle.

15. The system of claim 4, wherein each of the plurality of curved beams and the one or more concentric beams is formed from carbon fiber or fiberglass.

16. A method for an unmanned aerial vehicle, the method comprising:
affixing a mesh carapace to the unmanned aerial vehicle, the mesh carapace positioned above and at sides of the unmanned aerial vehicle; and
operating the unmanned aerial vehicle in an obstructive environment,
wherein the mesh carapace is assembled from a plurality of beams removably joined via a plurality of joints, and
wherein the mesh carapace maintains uninterrupted rotation of propellers of the unmanned aerial vehicle when an obstructing object in the obstructive environment contacts the mesh carapace.

17. The method of claim 16, wherein each of a number of the plurality of beams and a number of joints is increased as an average size of obstructing objects in the obstructive environment decreases.

18. The method of claim 16, wherein the obstructive environment comprises plant foliage harboring an avian habitat.

19. The method of claim 16, further comprising affixing a mesh netting to the mesh carapace, the mesh netting covering an exterior of the mesh carapace, the exterior being opposite to an interior of the mesh carapace facing the unmanned aerial vehicle, and a mesh of the mesh netting being finer than a mesh of the mesh carapace.

20. The method of claim 16, further comprising, following operation of the unmanned aerial vehicle:
removing the mesh carapace from the unmanned aerial vehicle;
disassembling the mesh carapace by separating the plurality of beams from the plurality of joints; and
prior to subsequent operation of the unmanned aerial vehicle:
reassembling the mesh carapace from the plurality of beams and the plurality of joints; and
reaffixing the reassembled mesh carapace to the unmanned aerial vehicle.
